(19) United States
(12) Patent Application Publication
(10) Pub. No.: US 2026/0344592 A1
(43) Pub. Date: Nov. 5, 2026

(54) PLANT SUPPORT STRUCTURE AND SYSTEM

(71) Applicant: ECO SHIELD SYSTEMS PTY LTD., Sydney (AU)

(72) Inventor: Daniel GRIFFIN, Sydney (AU)

(21) Appl. No.: 19/124,731

(22) PCT Filed: Oct. 30, 2023
(86) PCT No.: PCT/AU2023/051095

§ 371 Date: Apr. 25, 2025

(30) Foreign Application Priority Data
Oct. 28, 2022 (AU) 2022903212

(51) Int. Cl. A01G 27/04; A01G 9/02; A01G 9/24

(52) U.S. Cl. CPC A01G 27/04; A01G 9/025; A01G 9/247

(57) ABSTRACT

A plant support structure for accommodating plants, the plant support structure including: a framework including a plurality of elements interconnected to each other in a vertically extending arrangement, each element having a hollow lattice structure defining an internal void, wherein the internal void of each of the plurality of elements are interconnected and define at least one substantially vertical interconnected void extending though the plurality of elements and the framework.

### CROSS REFERENCE TO RELATED APPLICATION

This application is related to Australian Provisional Patent Application No 2022903212 filed on 28 Oct. 2022, the contents of which are incorporated herein by reference in their entirety.

### FIELD OF THE INVENTION

The present disclosure relates to a plant support structure and plant support system for accommodating plants.

### BACKGROUND OF THE INVENTION

Over the last century, various human activities such as the clearing of forests and natural ecosystems for agriculture, industry, commercial and residential real estate and other human activities has decreased the amount of flora and fauna in the environment. For many, the absence of flora has a detrimental effect on at least the aesthetics of a built environment. The absence of fauna also has a detrimental effect on the flora and the biodiversity of the built environment. Additionally, many cities are beginning to suffer from a “heat island effect”, in which built up areas are hotter than nearby rural areas.

Recently, some systems such as green façade systems, green walls, and living walls have been developed to introduce nature into the urban environment. A green façade uses a trellis system to hold the vines of plants that are rooted in the ground whereas in a living wall the plants are rooted in the wall modules.

### SUMMARY OF THE INVENTION

According to a first aspect, there is provided a plant support structure for accommodating plants, the plant support structure including: a framework including a plurality of elements interconnected to each other in a vertically extending arrangement, each element having a hollow lattice structure defining an internal void, wherein the internal void of each of the plurality of elements are interconnected and define at least one substantially vertical interconnected void extending though the plurality of elements and the framework.

In an embodiment, the plant support structure further comprises a permeable substrate disposed in the at least one interconnected void, wherein the permeable substrate is configured to direct water flow through the at least one interconnected void.

In an embodiment, the permeable substrate is configured to support growth of plants growing in and through the at least one interconnected void.

In an embodiment, the permeable substrate is configured to at least partially guide growth of plants growing in and through the at least one interconnected void.

In an embodiment, the permeable substrate includes a plant growing media.

In an embodiment, the plant growing media includes a porous bag or lattice filled with a medium to support plant growth in and through the plant growing media.

In an embodiment, the permeable substrate includes a porous material.

In an embodiment, the porous material includes a wicking material or a geotextile.

In an embodiment, the framework has a first layer and a second layer of interconnected elements, the first layer being horizontally spaced apart from the second layer.

In an embodiment, at least one channel is defined between the first layer and the second layer; and plant growing media is disposed in the at least one channel, the plant growing media disposed in the at least one channel is configured to direct water flow through the at least one channel.

In an embodiment, the plant growing media disposed in the at least one channel is configured to support plant growth of plants growing in the at least one channel.

In an embodiment, the plant growing media disposed in the at least one channel includes a porous bag or lattice filled with a medium to support plant growth in the at least one channel.

In an embodiment, the framework at least partially guides growth of plants growing in the framework in and through the least one interconnected void and over and around the plurality of elements.

In an embodiment, the plant support structure is a façade of a building, a freestanding pavilion/wall, or a fence.

In an embodiment, the plurality of elements are formed from a cementitious material.

In an embodiment, the cementitious material is one of lightweight cast concrete, carbon capture concrete, carbon capture cementitious materials, steel reinforced concrete, and fibre reinforced concrete.

According to a second aspect, there is provided a plant support system accommodating and maintaining plants, the plant support system including: a plant support structure according to the first aspect; a permeable substrate disposed in the at least one interconnected void, wherein the permeable substrate is configured to direct water flow through the at least one interconnected void; and an irrigation system configured to deliver water to the permeable substrate.

In an embodiment, the plant support system further comprises a water treatment pond located near a bottom end of the plant support structure, wherein the water treatment pond is configured to receive and treat water resulting from irrigation overflow through the framework of the plant support structure.

In an embodiment, the plant support system further comprises a water storage tank configured to receive treated water from the water treatment pond.

In an embodiment, the plant support system further comprises a cistern located at a height close or above the height of the plant support structure, wherein the cistern receives water from the water storage tank and provides the water to the irrigation system.

In an embodiment, the plant support system further comprises a power source and a pump for pumping water from the water storage tank to the cistern.

In an embodiment, the pump is powered by solar energy to pump the water to the cistern.

According to a third aspect, there is provided a method comprising, manufacturing or installing at a site a plant support structure of the first aspect, disposing a permeable substrate in the at least one interconnected void, wherein the permeable substrate is configured to direct water flow through the at least one interconnected void; and providing plants for growth on the plant support structure, wherein the plant growth is supported at least on part by the permeable substrate.

According to a fourth aspect, there is provided a method comprising, manufacturing or installing at a site a plant support system of the third aspect, and providing plants for growth on the plant support structure, wherein the plant growth is supported at least on part by the permeable substrate.

In an embodiment, the plants are provided on the plant support structure by including seeds, spores, mineral, or other organic material that promote growth of biological organisms in or on the permeable substrate.

### BRIEF DESCRIPTION OF THE DRAWINGS

Preferred embodiments of the invention will be described, by way of examples only, with reference to the accompanying figures, wherein;

FIG. 1 shows a plant support structure according to an embodiment of the present disclosure;

FIG. 2 shows an element used to construct the plant support structure of FIG. 1;

FIG. 3 shows the element of FIG. 2 with plant growing media disposed in the internal void of the element;

FIG. 4 shows a plant support structure according to another embodiment of the present disclosure;

FIG. 5 shows an element used to construct the plant support structure of FIG. 4 with porous material disposed in the internal void of the element;

FIG. 6 shows a plant support structure according to another embodiment of the present disclosure;

FIG. 7 shows an enlarged section of the plant support structure of FIG. 6;

FIG. 8 shows a plant support system according to an embodiment of the present disclosure;

FIG. 9 shows a mould in which the elements of FIGS. 2 and 5 may be fabricated;

FIG. 10 shows a fabricated element within the mould of FIG. 9;

FIG. 11 shows an example of plant growing media that may be used with the plant support structures of FIGS. 1, 4, and 6;

FIG. 12 shows a fabricated element within the mould of FIG. 9 with plant growing media disposed around the element within the mould; and

FIG. 13 shows the element shown in FIG. 12 with plant growing media cast around it.

### DETAILED DESCRIPTION OF THE EMBODIMENTS

The systems disclosed herein relate to plant support structures and plant support systems for accommodating and growing flora.

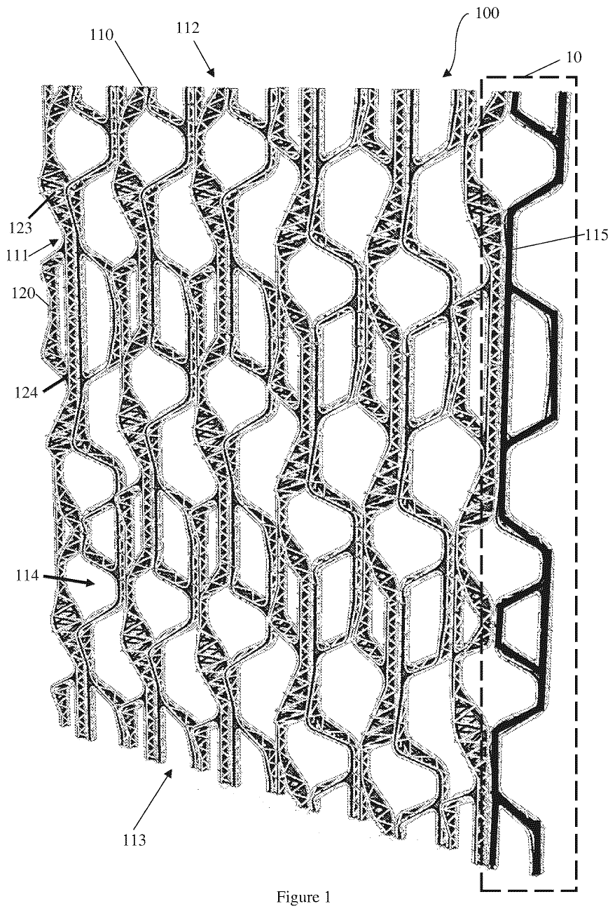

FIG. 1 shows a plant support structure 100 according to an embodiment of the present disclosure. The plant support structure 100 includes a framework 110 having a plurality of interconnected elements 120.

The framework 110 is defined by the plurality of interconnected elements 120. The framework 110 has a top end 112 and a bottom end 113 opposite the top end 112. The framework 110 also has a plurality of openings 114 defined by the plurality of interconnected elements 120. The plurality of openings 114 allow light to pass through the framework 110. In some embodiments, like the embodiment shown in FIG. 1, the framework 110 forms a single layer 111.

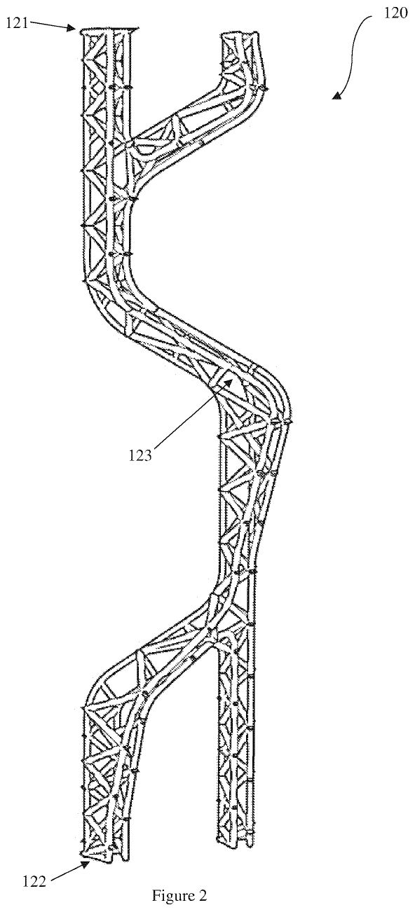

FIG. 2 shows a single element 120 from the framework 110. Each element 120 has a first end 121 and a second end 122 opposite the first end 121. Each element 120 also has a hollow lattice structure defining an internal void 123 extending between the first end 121 and the second end 122.

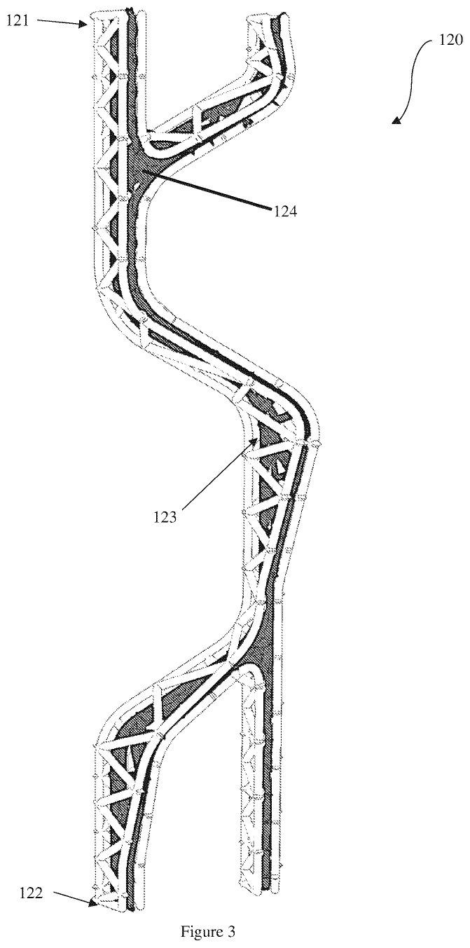

FIG. 3 shows a single element 120 from the framework 110 together with plant growing media 124. In some embodiments, one or more of the elements 120 in the framework 110 have plant growing media 124 disposed in the internal void 123. In some embodiments, a plurality of elements 120 that are vertically adjacent each other in the framework 110 have plant growing media 124 disposed in their respective internal voids 123, thereby creating a column of plant growing media 124. In some embodiments, the framework 110 includes a plurality of such columns of plant growing media 124. In some embodiments, all or substantially all of the elements 120 forming the framework 110 have plant growing media 124 disposed in their respective internal voids 123.

For each element 120 with plant growing media 124, the plant growing media 124 may extend between the first end 121 and the second end 122. In this way, a continuous or substantially continuous column of plant growing media 124 may be formed within the framework 110. In other embodiments, there may be a vertical gap between plant growing media 124. Where there is a vertical gap, the lowest part of plant growing media 124 from an upper element 120 may align with the highest part of plant growing media 124 from an adjacent lower element 120, thereby allowing water to drip from the plant growing media 124 of the upper element 120 to the plant growing media of the lower element 120.

Plants may be planted in the plant growing media 124 and grow through the plant growing media 124. Accordingly, the plant growing media 124 is configured to support growth of plants. The plant growing media 124 may be any suitable plant growing media, for example a porous bag or lattice filled with suitable medium to support plant growth, wicking fabric, 3D printed extruded bound (solid) plant growing media. Each of these options may include organic media (e.g. composted organic matter, recycled coffee grounds, organic fertilizers) that may be in (e.g. impregnated in), on, or encapsulate the plant growing media 124 in order to support plant growth in, on, and/or through the plant growing media 124. However, it will be appreciated that the particular plant growing media 124 disposed in the internal voids 123 of each of the elements 120 may depend on the type of plants that are intended to be accommodated by the plant support structure 100. In some embodiments, organic plant supporting media comprising seeds, spores, minerals, fertilizers, and/or nutrients may be combined, impregnated, and/or applied to the surface of the plant growing media 124. In some embodiments, organic plant supporting media comprising seeds, spores, minerals, fertilizers, and/or nutrients may be mixed within the material forming the elements 120. The organic plant supporting media may promote growth of plants and/or other biological organisms.

The plant growing media 124 may be connected to the elements 120 using any suitable attachment mechanism. As an example, the plant growing media 124 may be connected to the elements 120 using netting, caging, and/or mechanical fasteners. Alternatively, the plant growing media 124 may be cast into (i.e. integral with) the material forming the elements 120, woven around the elements 120, or tied to the elements 120. It will be appreciated that suitable attachment mechanisms for connecting the plant growing media 124 to the elements 120 may also be dependent on the particular type of plant growing media being used.

Referring back to FIG. 1, in the framework 110, the top and bottom ends of the elements 120 are connected to the bottom and top ends of vertically adjacent elements 120 in the framework 110, such that elements 120 are interconnected to each other in a vertically extending arrangement in the framework 110. Depending on the orientation of each element 120 in the framework 110, the top end of the elements 120 is one of the first end 121 and the second end 122 and the bottom end of the elements 120 is the other of the first end 121 and the second end 122. It will be appreciated that the bottom ends of the bottommost elements 120 in the framework 110 are not connected to other elements 120 and, similarly, the top ends of the uppermost elements 120 in the framework 110 are not connected to other elements 120.

Referring to the vertically interconnected elements 120 in the box 10 in FIG. 1, the internal voids 123 of these interconnected elements 120 are interconnected and define a interconnected void 115 extending through these elements 120. The interconnected void 115 may be substantially vertical. The interconnected void 115 therefore extends through the framework 110 between the bottom end 113 and the top end 112 of the framework 110. It will be appreciated that the framework 110 has a plurality of interconnected voids 115 extending through the framework 110 that are defined by other vertically interconnected elements 120 in the framework 110. It will also be appreciated that horizontally adjacent interconnected voids 115 may interconnect/intersect such that water may flow between the interconnected voids 115.

Disposed in each of the interconnected voids 115 of the framework 110 is the plant growing media 124 of the vertically interconnected elements 120 defining the respective interconnected voids 115. Accordingly, plant growing media 124 is disposed in and extends through each of the interconnected voids 115 of the framework 110. This may allow for root-ball integration between vertically adjacent elements 120 in the framework 110, which may allow a monolithic root structure to form that extends continuously through an interconnected void 115 of the framework 110.

The plant growing media 124 in each interconnected void 115 is configured to direct water through the interconnected void 115 from the top end 112 to the bottom end 113 of the framework 110. Water, fertilisers, and other fluids or materials may be delivered into the plant growing media 124 in each of the interconnected voids 115 at the top end 112 of the framework 110 via an irrigation system (not shown).

Plants may be planted in the plant growing media 124 in each of the interconnected voids 115 and the plant growing media 124 is configured to support growth of the plants. Depending on the plants growing in the plant growing media 124, the roots of the plants will grow following the movement of water through the plant growing media 124. The plant growing media 124 disposed in each interconnected void 115 may therefore at least partially guide growth of the plants in and through the interconnected void 115. Accordingly, plants growing in the plant growing media 124 are able to grow in and through the interconnected voids 115 and over and around the elements 120.

As an example, depending on the plants growing in the plant growing media 124, the plants may grow in and through the interconnected voids 115 and over and around the elements 120 in such a way that the plants become a partially or fully self-supporting structure. The framework 110 therefore may become at least partially structurally redundant. Accordingly, in this example, the plant support structure 100 guides the growth of plants through and over the framework 110 such that the plants will grow into a self-supporting structure and the framework 110 becomes structurally redundant. Examples of plants that could be grown in the plant support structure 100 and grow into a self-supporting structure are strangler figs, Ficus Microcarpa, Ficus oblongifolia, Ficus Rubiginosa Ficus Elastica, other species of Ficus, or other rainforest or lithophytic trees.

Although the elements 120 have been illustrated having a particular shape defining an internal void 123 having a particular shape, each of the elements 120 may have different shapes defining internal voids 123 having different shapes. The plant growing media 124 may be disposed in the internal voids 123 of the elements 120 having different shapes and configurations. Accordingly, the framework 110 may be constructed from elements 120 having different shapes defining internal voids 123 of different shapes with plant growing media 124 of different shapes and configurations disposed in the internal voids 123 of the elements 120. In this way, different configurations of the framework 110 may be constructed that guide the growth of plants growing in and through the interconnected voids 115 and over and around the elements 120 according, at least partially given natural variations, to a predetermined pattern. For example, the framework 110 may be constructed to guide the growth of Ficus growing in, through, and over the framework 110 that has a shape that encourages plant growth according to a predetermined structural geometry, such that the Ficus roots form a self-supporting structure.

Each element 120 is connected to vertically and horizontally adjacent elements 120 in the framework 110 using any suitable connectors (not shown) and/or methods known in the art. The connectors may be in the form of brackets, metal tubes, or metal rods, which are capable of securely connecting elements 120 together and assembling the framework 110. The connectors may be made of a suitable lightweight metal, for example, aluminium. Alternatively, the connectors may be made of any suitable weather resistant material, for example, stainless steel. Alternatively or additionally the connection may be by an adhesive. In some embodiments, like connectors may be used to connect each element 120 to the plant growing media 124 or to a holder of the plant growing media 124, such as a wire mesh or cable loops. In an embodiment where the plant support structure 100 acts as a façade for a building (not shown), the framework 110 may be coupled to a supporting structure of the building using connectors, which may be in the form of brackets, metal tubes, or metal rods, which are capable of securely connecting the framework 110 to the support structure(s) of the building.

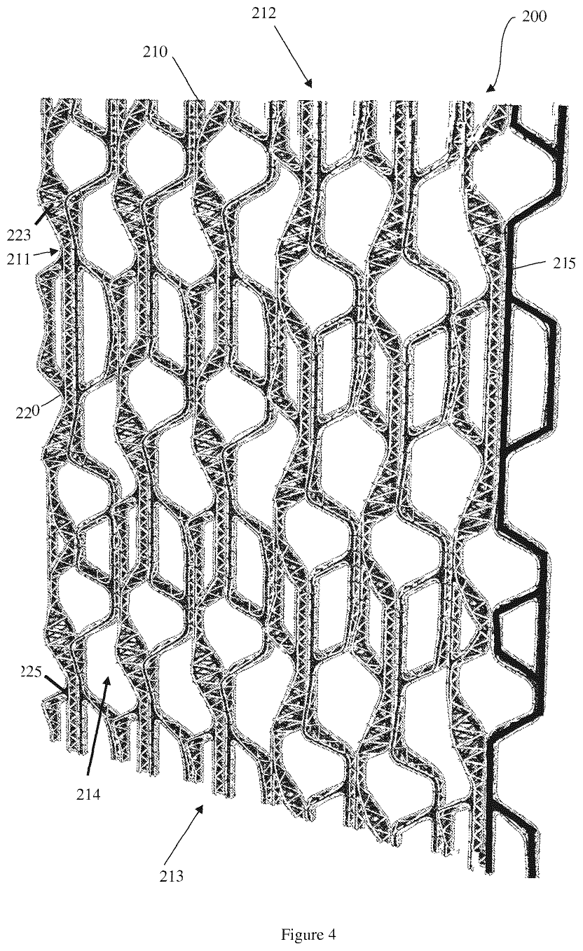

FIG. 4 shows a plant support structure 200 according to another embodiment of the present disclosure. The plant support structure 200 is similar to the plant support structure 100. However, the plant support structure 200 differs from the plant support structure 100 in that a porous material 225 is disposed in the internal voids 223 of the elements 220 instead of the plant growing media 124 disposed in the internal voids 123 of the elements 120 of the plant support structure 100.

Features of the plant support structure 200 that are identical or equivalent to those of the plant support structure 100 are provided with reference numerals that are equivalent to those of the plant support structure 100 but incremented by 100. For features that are identical between the plant support structure 100 and the plant support structure 200, it will be appreciated that the above description of these features in relation to the plant support structure 100 is also applicable to the corresponding identical/equivalent features found in the plant support structure 200. Accordingly, the identical features between the plant support structure 100 and the plant support structure 200 will not again be described below in relation to the plant support structure 200 as these features of the plant support structure 200 have already been described above with respect to the plant support structure 100.

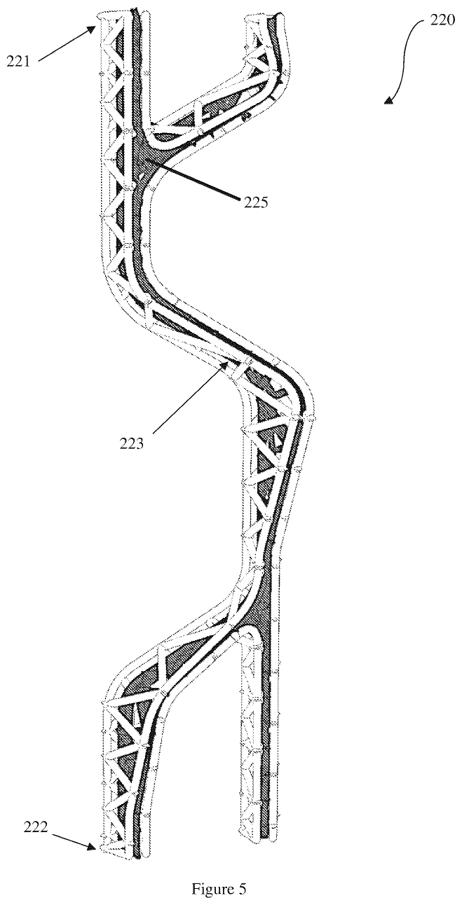

Referring to FIG. 5, for each element 220, the porous material 225 extends between the first end 221 and the second end 222. The porous material 225 disposed in the internal voids 223 of the elements 220 may be a wicking material, a geotextile, specifically formulated lightweight plant growing media, and bound and extruded (e.g. via 3D printing) plant growing media that may be formed into particular geometric forms. The porous material 225 of each element 220 is configured to direct water through the element 220 and is configured to have plants planted in, on, and through it. The porous material 225 may be woven through and tied to the elements 220 or connected to the elements 220 using mechanical fasteners. Alternatively, the porous material 225 may be cast in and around the elements 220 (e.g. in bound solid media form extruded from a robotic print head), encapsulate the elements 220, or be cast around the elements 220. In some embodiments, organic plant supporting media comprising seeds, spores, minerals, fertilizers, nutrients may be combined, impregnated, or applied to the surface of the porous material 225. In some embodiments, organic plant supporting media comprising seeds, spores, minerals, fertilizers, nutrients may be mixed within the material forming the elements 220. The organic plant supporting media may promote growth of plants and/or other biological organisms.

Referring to FIG. 4, disposed in each of the interconnected voids 215 of the framework 210 is the porous material 225 of the vertically interconnected elements 220 defining the respective interconnected voids 215. Accordingly, porous material 225 is disposed in and extends through each of the interconnected voids 215 of the framework 210. This may allow for root-ball integration between vertically adjacent elements 220 in the framework 210, which may allow a monolithic root structure to form that extends continuously through an interconnected void 215 of the framework 210.

The porous material 225 in each interconnected void 215 is configured to direct water through the interconnected void 215 from the top end 212 to the bottom end 213 of the framework 210. Water, fertilisers, and other fluids or materials may be delivered into the porous material 215 in each of the interconnected voids 215 at the top end 212 of the framework 210 via an irrigation system (not shown).

Similar to the plant support structure 100, plants growing in the framework 210 will follow the movement of water through the interconnected voids 215, which is directed by the porous material 225 disposed in the internal voids 223 of the elements 220. The porous material 225 disposed in each of the interconnected voids 215 may therefore at least partially guide the growth of plants in and through the interconnected voids 215. Accordingly, similar to the plant support structure 100, plants growing in the framework 210 are able to grow in and through the interconnected voids 215 and over and around the elements 220.

In some embodiments, the porous material 225 is disposed in the internal voids 223 of the elements 220 in different configurations to that illustrated in FIG. 4. Similar to that described above with respect to the plant support structure 100, in some embodiments the framework 220 may be constructed from elements 220 having different shapes defining internal voids 223 of different shapes with porous material 225 disposed in the internal voids 223 of the elements 220 with different configurations. In this way, different configurations of the framework 220 may be constructed that guide the growth of plants growing in and through the interconnected voids 215 and over and around the elements 220 according, at least partially given natural variations, to a predetermined pattern.

The plant growing media 124 may be used in circumstances where relatively quick greening is required. For example, the plant growing media 124 may support a variety of species of epiphyes and lithophytes, as well as other similar plants. Further, the plant growing media 124 may be initially planted with a variety of species of epiphyes and lithophytes, and/or seedlings of other plant species during construction of the plant support structure 100 such that relatively quick greening may be achieved. Ficus, or other tree roots would still be able to grow through the plant growing media 124 and connect to form a monolithic root-ball structure, as already described above. As the ficus and/or other tree roots mature, the roots will swell displacing the plant growing media 124 bound by the root-balls of the other plants. In this case, the plant growing media 124 may contain a thin tendril of wicking fabric disposed within and extending through the plant growing media 124. This may control the movement of water through the framework 110 and where the ficus and/or other tree roots will grow. This may form a more resilient ecosystem capable of withstanding harsher environments before maturation.

In other circumstances, the plant support structure 200 may be used where relatively quick greening is not required. For example, the plant support structure 200 may be initially constructed without any, or with few plants, accommodated by the framework 210. The porous material 225 (e.g. a wicking fabric) may be used to control the flow of water through the framework 210 and plants may subsequently grow through, over, and around the framework 210 following the flow of water through the framework 210. The plant support structure 200 may be a cheaper and easier system to construct compared to the plant support structure 100 which uses the plant growing media 124. However, greening may take longer to achieve compared to the plant support structure 100. The plant support structure 200 may be less resilient compared to plant support structure 100 and plants may require pre-growth in controlled greenhouse conditions to reach maturation before installation into the framework 210. However, plant support structure 200 may allow for visible inspection of the roots of the ficus, or other trees, given they will not be surrounded by plant growing media 124 as will be the case in plant support structure 100.

Although the plant support structure 100 has been described and illustrated above as only having plant growing media 124 disposed in the internal voids 123 of the elements 120, in some embodiments, the porous material 225 may be disposed in the internal voids 123 of one or more of the elements 120 of the framework 110 instead of or together with the plant growing media 124. Similarly, although the plant support structure 200 has been described and illustrated above as only having the porous material 225 disposed in the internal voids 223 of the elements 220, in some embodiments, the plant growing media 124 may be disposed in the internal voids 223 of one or more of the elements 220 of the framework 210 instead of or together with the porous material 225.

As water may flow in and through the plant growing media 124 and/or the porous material 225, it will be appreciated that both the plant growing media 124 and the porous material 225 are permeable substrates. Accordingly, in some embodiments, the plant growing media 124 of the plant support structure 100 and the porous material 225 of the plant support structure 200 may be replaced with any other suitable permeable substrate that would be capable of directing water through the interconnected voids 115 of the plant support structure 100 and the interconnected voids 215 of the plant support structure 200. It will be appreciated that the type of permeable substrate used may be dependent on the plants intended to grow in, on, and/or through the permeable substrate.

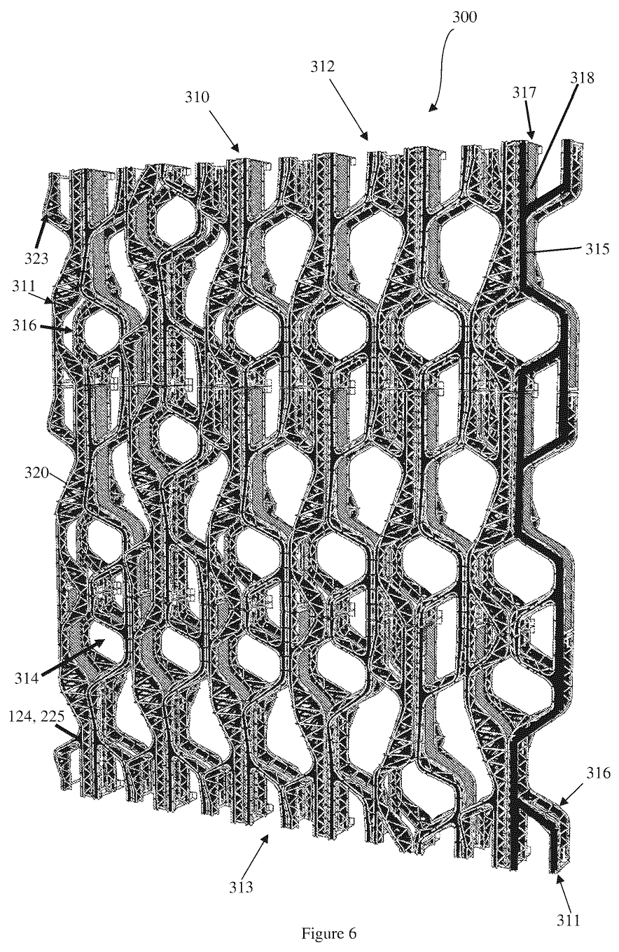

FIG. 6 shows a plant support structure 300 according to another embodiment of the present disclosure. The plant support structure 300 is similar to the plant support structure 100. However, the framework 310 of the plant support structure 300 has a first layer 311 of interconnected elements 320 and a second layer 316 of interconnected elements 320 instead of the single layer 111 of interconnected elements 120 of the plant support structure 100.

Features of the plant support structure 300 that are identical or equivalent to those of the plant support structure 100 are provided with reference numerals that are equivalent to those of the plant support structure 100 but incremented by 200. For features that are identical between the plant support structure 100 and the plant support structure 300, it will be appreciated that the above description of these features in relation to the plant support structure 100 is also applicable to the corresponding identical/equivalent features found in the plant support structure 300. Accordingly, the identical features between the plant support structure 100 and the plant support structure 300 will not again be described below in relation to the plant support structure 300 as these features of the plant support structure 300 have already been described above with respect to the plant support structure 100.

The first layer 311 of interconnected elements 320 may be constructed according to the layer 111 of the plant support structure 100 or the layer 211 of the plant support structure 200. The second layer 316 of interconnected elements 320 may be constructed according to the layer 111 of the plant support structure 100 or the layer 211 of the plant support structure 200.

The first layer 311 and the second layer 316 are horizontally spaced apart from each other. The first layer 311 and the second layer 316 may be structurally independent of each other or may be structurally interconnected using any suitable connectors and/or methods.

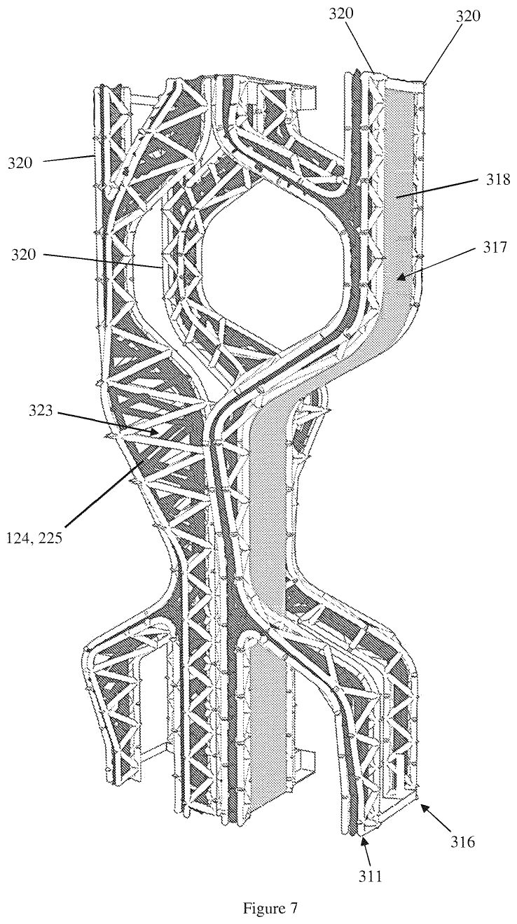

As best seen in FIG. 7, defined between the first layer 311 and the second layer 316 is a plurality of channels 317 (only one labelled for clarity of illustration). Each channel 317 is defined between the periphery of elements 320 of the first layer 311 and the periphery of elements 320 of the second layer 316. The distance between the first layer 311 and the second layer 316 and, therefore, the width of the channels 317 may vary between installations. By way of example, the channels 317 may range in width between about 10 cm to about 2 m (inclusive).

Disposed in each channel 317 is plant growing media 318. The plant growing media 318 extends from the top end 312 to the bottom end 313 of the framework 310. The plant growing media 318 may be disposed in the channels 318 by connecting the plant growing media 318 between the first layer 311 and the second layer 316. The plant growing media 318 may be connected between the first layer 311 and the second layer 316 using any suitable mechanism. As an example, the plant growing media 318 may be connected between the first layer 311 and the second layer 316 using netting, caging, mechanical fasteners, or clips that connect to one or more cables that extend across the channel 317 and that are connected to one or more elements 320 in the first layer 311 and the second layer 316. It will be appreciated that suitable mechanisms for connecting the plant growing media 318 between the first layer 311 and the second layer 316 may also be dependent on the particular type of plant growing media being used.

For each channel 317, plants may be planted in the plant growing media 318 and grow through the plant growing media 318. Accordingly, the plant growing media 318 is configured to support growth of plants. The plant growing media 318 may be any suitable plant growing media known in the art (e.g. a porous bag or lattice filled with suitable medium to support plant growth). The plant growing media 318 may also be the same or different to the plant growing media 124. However, it will be appreciated that the particular plant growing media 318 disposed in the channels 317 may depend on the type of plants that are intended to be accommodated in the channels 317.

The plant growing media 318 in each channel 317 is configured to direct water down through the channel 317 from the top end 312 to the bottom end 313 of the framework 310. This may allow for root-ball integration through each channel 317 to form a monolithic root structure that may extend continuously through the channel 317 of the framework 310. Water, fertilisers, and other fluids or materials may be delivered into the plant growing media 318 in each of the channels 317 at the top end 312 of the framework 310 via an irrigation system (not shown). In some embodiments, organic plant supporting media comprising seeds, spores, minerals, fertilizers, nutrients may be combined, impregnated, or applied to the surface of the plant growing media 318. In some embodiments, organic plant supporting media comprising seeds, spores, minerals, fertilizers, nutrients may be mixed within the material forming the elements 320.

In the plant support structure 300, plants may grow in and through the interconnected voids 315 of the first layer 311 and the second layer 316 and over and around the elements 320 of the first layer 311 and the second layer 316 similar to that described above with respect to plant support structures 100 and 200. Plants may also grow in and through the channels 317 of the plant support structure 300.

Although the plant support structure 300 has been described above with plant growing media 318 disposed in the channels 317, it will be appreciated that any suitable permeable substrate that can support growth of plants may be disposed in the channels 317.

Depending on the types of plants growing in the channels 317, plants growing in the channels 317 may also grow over and around elements 320 of the first layer 311 and/or the second layer 316. Further, these plants may also end up growing in and through the interconnected voids 315 of the first layer 311 and the second layer 316.

Similar to that described above with respect to plant support system 100, the first layer 311 and the second layer 316 may be constructed having different configurations that may guide the growth of plants over and through the framework 310. Depending on the types of plants growing in the framework 310, plants growing in the first layer 311, plants growing in the second layer 316, and plants growing in the channels 317 may grow to eventually intertwine to form a self-supporting structure.

Further, similar to that described above with respect to plant support system 100, different configurations of the first layer 311 and the second layer 312 of the framework 310 may be constructed in order to guide growth of plants over and through the framework 310 according, at least partially given natural variations, to a predetermined pattern.

In some embodiments, the plant support structure 300 may have more than two layers of interconnected elements 320. Further, the heights of each layer may vary. For example, a rearmost layer may be the highest layer and the height of each subsequent layer going forward from the rearmost layer may decrease, thereby producing a framework 310 that is similar to a flying buttress.

The plant support structures 100, 200, 300 can be in the form of a building façade, a freestanding pavilion/wall, or a fence. In embodiments in which the plant support structure 100, 200, 300 acts as a building façade structure for an external face of a building, the elements 120, 220, 320 are connected together to form a plant support structure 100, 200, 300 that spans the external face of the building and is anchored to support elements/concrete slabs or similar of the building. In an alternative embodiment, in which the plant support structure 100, 200, 300 is a freestanding pavilion or fence, the elements 120, 220, 320 may be supported by concrete block foundations or water tanks disposed within, partially within, or on the ground.

As the frameworks 110, 210, 310 are constructed by interconnecting a plurality of elements 120, 220, 320, it will be appreciated that frameworks 110, 210, 310 of varying heights and widths may be constructed by varying the number of elements 120, 220, 320 interconnected vertically and varying the number of elements 120, 220, 320 interconnected horizontally. The use of interconnecting elements facilitates manufacture at one location and assembly at another. In other embodiments, any of the frameworks 110, 210, 310 are integrally formed, for example by manufacturing the frameworks on-site. Furthermore, while each element 120, 220, 320 described above generally forms one vertical channel, which alternates between two parallel paths and a single serial path, in other embodiments each element may form only a single serial path or may form two or more vertical paths.

A method of manufacturing or installing the plant support structures 100, 200, 300 at a site (e.g. in front of a building so as to act as a building façade) may include interconnecting a plurality of elements 120, 220, 320 to form the frameworks 110, 210, 310. As described above, frameworks 110, 210, 310 of varying heights and widths may be constructed by varying the number of elements 120, 220, 320 interconnected vertically and varying the number of elements 120, 220, 320 interconnected horizontally. The height and width of the frameworks 110, 210, 310 may depend on the intended application and installation site of the plant support structures 100, 200, 300.

The method further includes disposing permeable substrates (e.g. plant growing media 124 and/or porous material 225) that are able to support growth of plants in the interconnected voids 115, 215, 315 and any channels (e.g. channels 317 of framework 310) of the frameworks after the frameworks have been constructed. Alternatively, the method may include disposing permeable substrates in the internal voids 123, 223, 323 of the elements 120, 220, 320 before the frameworks 110, 210, 310 are constructed. For frameworks having channels (e.g. channels 317 of framework 310), the permeable substrate may be disposed in the channels after the framework has been constructed.

The method further includes positioning plants and/or seedlings on/in the frameworks 110, 210, 310 after the frameworks 110, 210, 310 are constructed. How the plants and/or seedlings are positioned on/in the frameworks 110, 210, 310 may be dependent on the type of plants. For example, plants and/or seedlings may be planted in the permeable substrate or on the elements proximate the permeable substrate. Alternatively, the method may include providing plants and/or seedlings on/in the elements 120, 220, 320 before the frameworks 110, 210, 310 are constructed.

In some embodiments, the permeable substrates and/or the elements 120, 220, 320 may include seeds, spores, and organics/minerals. Such permeable substrates may be positioned in/on the frameworks 110, 210, 310 after the frameworks 110, 210, 310 have been constructed or in/on the elements 120, 220, 320 before the frameworks 110, 210, 310 have been constructed. In such embodiments, plants may grow from the seeds and spores after the permeable substrates have been exposed to water (e.g. via rain and/or an irrigation system).

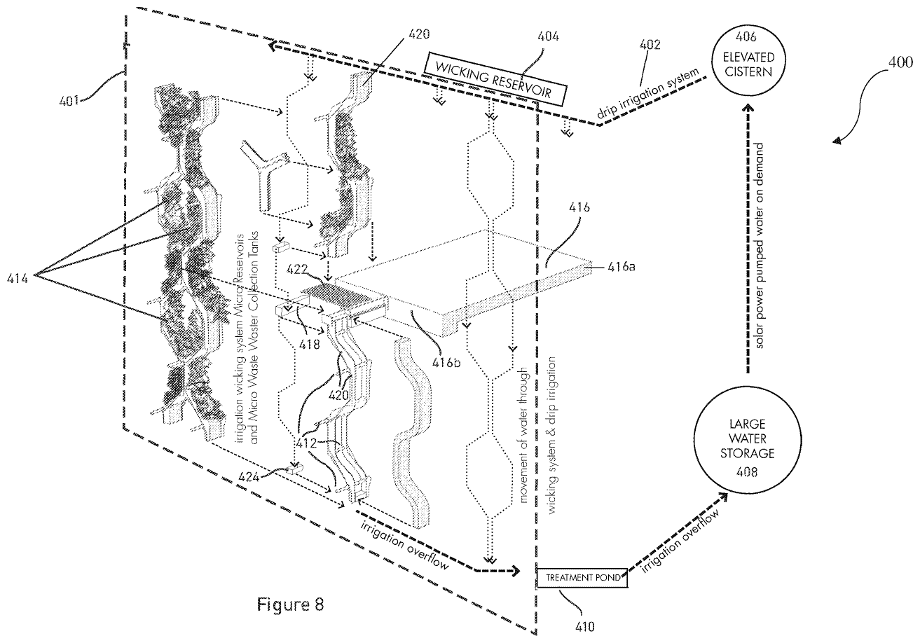

FIG. 8 shows a plant support system 400 according to an embodiment of the present disclosure. The plant support system 400 has a plant support structure 401 and components of a water supply system. The plant support structure 401 is only partially illustrated for clarity of illustration. The water supply system components include a drip irrigation system 402, a reservoir 404, an elevated cistern 406, a water storage tank 408, and a water treatment pond 410. The plant support structure 400 may be any one of the plant support structures 100, 200, and 300 disclosed herein.

In FIG. 8, an exploded view of the plant support system 400 is shown to elucidate an embodiment of how various parts of the plant support structure 401 may be assembled and secured together. It will be appreciated that there are various alternative methods of assembling and securing the components in place.

The plant support structure 401 comprises interconnecting elements 420. The interconnecting elements 420 may include any of the elements disclosed herein. The interconnecting elements 420 are connected together using connectors such as brackets, metal tubes, or metal rods to form a framework of the plant support structure 401. In this embodiment, the connectors are formed from aluminium tubes 412. The plant support structure 401 has a plurality of openings 414 defined by the interconnecting elements 420. In this embodiment, the openings 414 are shown to have hexagonal geometry.

The plant support system 400 further includes or is connected to one or more support elements 416 for supporting the plant support structure 401. In an embodiment, each support element 416 is a concrete slab that is secured to or forms part of a building/wall/other structure at its rear face 416a. A fastener 418 secures the plant support structure 401 to the support element/concrete slab 416 at its front face 416b. In this way, the plant support structure 401 is held in place in an upright position. One or more support elements 416 may be used based on the size of the plant support structure 401.

In an embodiment, a maintenance platform 422 is secured to the concrete slab 416 and supported by fasteners 418. The maintenance platform 422 may provide access to maintenance personnel to the plant support structure 401, to enable structure and/or plant maintenance. Stairs, ladders or similar (not shown) may be provided between platforms 422 to provide an additional exit from a structure attached to or by the plant support system 400. Where the structure is a building, these may provide, for example, a fire escape from the building.

The plant support structure 401 is configured to receive water from the drip irrigation system 402 which is connected in fluid communication to the reservoir 404 and the elevated cistern 406. If the plant support structure 401 is constructed according to the plant support structure 100 or 200, the drip irrigation system 402 is configured to deliver water, fertilisers, and other fluids or materials into the plant growing media or porous material in each of the interconnected voids 115 or 215 at the top end of the plant support structure 401. If the plant support structure 401 is constructed according to the plant support structure 300, the drip irrigation system 402 is configured to deliver water, fertilisers, and other fluids or materials into the plant growing media or porous material in each of the interconnected voids 315 of the first layer 311 and the second layer 316 and deliver water, fertilisers, and other fluids or materials into the plant growing media 318 in each of the channels 317 at the top end of the plant support structure 401.

During irrigation of plants in the plant support structure 401, some overflow of water might take place, which can be collected in the water treatment pond 410 that is provided near the bottom end of the plant support structure 401. In an example, the plant support system 400 may have a plurality of water collectors 424 disposed at the bottom of the plant support structure 401. Each collector 424 is configured to collect water flowing out of the bottom ends of the interconnected voids and any channels of the plant support structure 401 during irrigation of plants growing in, through, and over the plant support structure 401. Each collector 424 is in fluid communication with the water treatment pond 410 and any excess water in the collectors 424 may flow into the water treatment pond 410.

After water treatment at the water treatment pond 410, the treated water can be moved to the water storage tank 408. The treated water can then be pumped from the water storage tank 408 into the elevated cistern 406 that is located at a height above the top edge of the plant support structure 401. The plant support system 400 may also include a solar power system (not shown) that can produce sufficient solar power to pump the treated water into the elevated cistern 406. The drip irrigation system 402 takes water from the elevated cistern 406 and/or from the reservoirs 404 and delivers this water into the plant support structure 401 as described above. The plant support system 400 may also be coupled in fluid communication to an external water supply (e.g. mains water). The external water supply may provide water to the plant support system 400, for example to the cistern 406 or to the water storage tank 408.

The plant support system 400 of the present disclosure is a system that may mimic, to some extent, the complex ecosystem of forests to support plant growth and thus provide an “artificial” habitat for insects, reptiles, birds and other fauna. Therefore, these systems may also help address the issues of rapidly decreasing biodiversity in urban areas.

A method of installing a plant support system (e.g. plant support system 400) may include manufacturing or installing a plant support structure (e.g. plant support structure 401) at an intended site. The plant support system may be installed as a building façade, freestanding pavilion/wall, or fence. The plant support structure may be constructed using similar methods to those described above with respect to plant support structures 100, 200, 300. The method further includes providing plants, seedlings, spores, and/or seeds in/on the plant support structure. The plants, seedlings, spores, and/or seeds may be provided in/on the plant support structure using similar methods to those described above with respect to plant support structures 100, 200, 300. The method further includes installing an irrigation system that is configured to deliver water, fertilisers, and/or other fluids or materials to the plants growing in, through, and over the plant support structure. The irrigation system may include the drip irrigation system 402, the reservoir 404, the elevated cistern 406, the water storage tank 408, the water treatment pond 410, and the collectors 424 of the plant support structure 400. The drip irrigation system 402, the reservoir 404, the elevated cistern 406, the water storage tank 408, the water treatment pond 410, and the collectors 424 of the irrigation system may be installed as illustrated in FIG. 8.

The Applicant's co-pending International Patent Application No PCT/AU2021/050509 (PCT 509) describes several embodiments of facades, buildings, plant support structures, plant support systems, freestanding pavilions/walls, and fences. PCT 509 is incorporated herein by reference in its entirety.

In some embodiments, the plant support structures of the facades, buildings, plant support systems, freestanding pavilions/walls, and fences described in PCT 509 may be replaced/used with any one of the plant support structures 100, 200, and 300 described herein. For example:
the plant support structure 62 of building 60 described in PCT 509 may be replaced with any one the plant support structures 100, 200, and 300 described herein;
the plant support structures 107, 120, 121, 122, 130, 131, 132, 190, 200 described in PCT 509 may be any one of the plant support structures 100, 200, and 300 described herein;
the plant support structures of the plant support installations 140, 150, 160, 170, 180, 340 (i.e. freestanding pavilions/walls) may be replaced with any one the plant support structures 100, 200, and 300 described herein; and
the plant support structures of the plant support systems 270, 320, 390, 410, 420 described in PCT 509 may be replaced with any one of the plant support structures 100, 200, and 300 described herein.

In some embodiments:
elements 120, 220, 320 described herein may include the micro-awning 192 of the elements 191 described in PCT 509;
the plant support structures 100, 200, 300 described herein may include one or more of the basins 241 described in relation to the plant support structure 240 in PCT 509; and
the plant support structures 100, 200, 300 described herein may include one or more of the nesting boxes 251 described in relation to the plant support structure 250 in PCT 509.

The plant support structures and plant support systems disclosed herein may have multiple applications as a building façade, a retro-fittable building façade, a freestanding pavilion/wall, or a fence within or outside buildings, houses, and other real estate infrastructure.

Installation and operation of the plant support structures and plant support systems disclosed herein may allow buildings to cool down naturally and therefore reduce the cost of artificial cooling using air-conditioning and fans. Therefore, these systems may reduce the cost of operating a building with a reduction in the need for artificial cooling by reducing the heat load on the building. A well-ventilated plant support structure may cool down naturally, further reducing the heat load from radiation and/or reflected ambient heat.

The plant support structures and systems disclosed herein may also help in reducing heat island effect in congested city areas with multiple buildings and concrete infrastructure. These systems may reduce the heat island effect by shielding the thermal mass of buildings with a well ventilated plant support structure accommodating a variety of plants. The vegetation within the plant support structures provide a living shield. This may further reduce the heat gain, to the building, the building façade, and the surrounding built environment. The vegetation both shades as well as absorbs the sun radiation and heat energy, while the openings in the plant support structures allow light to pass through the plant support structure to the building behind the plant support structure.

Furthermore, the growing vegetation allows for the absorption of CO₂ and other harmful gases from the environment. The plant support structures disclosed herein may have a large plant surface area in a substantially vertical direction. Therefore, air purification may be achieved in a spatially efficient way.

The elements 120, 220, 320 disclosed herein may be manufactured from different materials and manufactured using different fabrication techniques.

The elements 120, 220, 320 may be made from cementitious material, metals (e.g. aluminium, steel) or any other suitable material known in the art. The elements 120, 220, 320 may be manufactured using casting techniques, 3D printing techniques, or any other suitable fabrication techniques known in the art.

As an example, the elements 120, 220, 320 disclosed herein may be formed of lightweight cast concrete, carbon capture concrete, carbon capture cementitious materials, or other impermeable or substantially impermeable material. Forming the elements 120, 220, 320 from carbon capture concrete and carbon capture cementitious materials may reduce the carbon footprint of the interconnecting element and basin.

In some embodiments, the elements 120, 220, 320 disclosed herein are made of a fibre (e.g. fibre) reinforced concrete or a steel reinforced concrete. Fibre reinforced concrete is concrete containing fibrous material. It contains short discrete fibres that are usually uniformly distributed and randomly oriented within the concrete. A carbon fibre reinforced concrete element is capable of carrying tension at strains greater than those at which cracking would initiate in a normal un-reinforced concrete element.

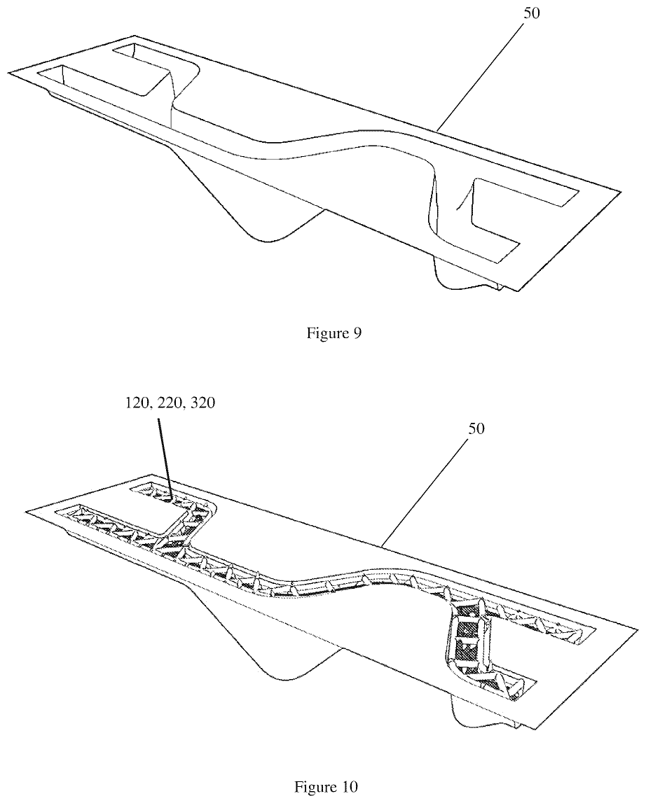

In some embodiments, the elements 120, 220, 320 may be manufactured from cementitious materials using 3D printing techniques. As an example, referring to FIG. 9, the elements 120, 220, 320 may be 3D printed in the mould 50 using any suitable 3D printing techniques, methods, or equipment known in the art. The mould 50 may be filled with supportive fluid/gel (not shown) and subsequently an element 120, 220, 320 may be 3D printed in the supportive fluid/gel in the mould 50 (see FIG. 10).

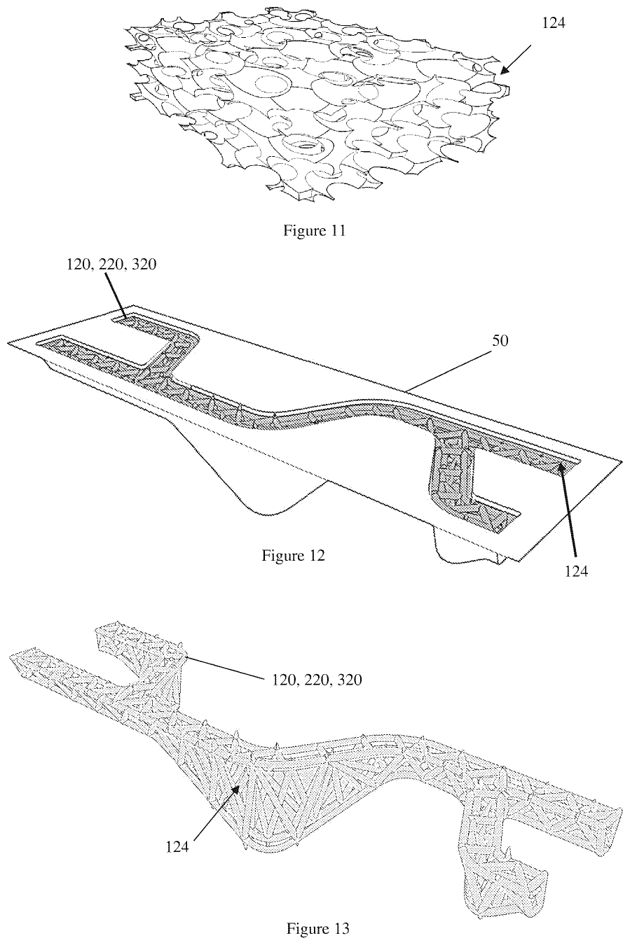

In an embodiment, the plant growing media 124 may be 3D printed in the supportive fluid/gel in the mould 50 simultaneously with the element 120, 220, 320 such that at the completion of the 3D printing process, the plant growing media 124 is disposed in the internal void 123, 223, 323 of the 3D printed elements 120, 220, 320. FIG. 11 shows an example of a section of plant growing media 124 that can be 3D printed using the above described method.

In another embodiment, after an element 120, 220, 320 has been 3D printed, the supportive fluid/gel may be removed/drained from the mould 50, leaving the 3D printed element 120, 220, 320 within the mould 50. Subsequently, plant growing media 124 may be introduced into the mould 50 such that plant growing media 124 is cast around the element 120, 220, 320 (see FIG. 12). Accordingly, the resulting element 120, 220, 320 is encased in plant growing media (see FIG. 13).

In another embodiment, the elements 120, 220, 320 may be formed from cementitious material using casting, 3D printing, or any other suitable fabrication techniques known in the art. The composition of the cementitious material may include spores, seeds, and organics/minerals such that the resulting hollow lattice structure of the element 120, 220, 320 has spores, seed, and organics/minerals embedded within it. In this embodiment, the element 120, 220, 320 may be covered with a waterproof material to prevent water reaching the spores, seeds, and organics/minerals embedded in the element 120, 220, 320. The waterproof material may be removed from the element 120, 220, 320 before constructing a plant support structure 100, 200, 300 using this element 120, 220, 320. The element 120, 220, 320 may then be exposed to water (e.g. via rain or an irrigation system), which flows into the element 120, 220, 320 to the spores, seeds, and organics/minerals embedded within it. In response to being exposed to water, plants may begin to grow from the spores and/or seed embedded in the element 120, 220, 320. The growth of the resulting plants may then be partially guided through the plant support structure 100, 200, 300 by plant growing media and/or porous material disposed in the plant support structure 100, 200, 300 as described above.

Although the elements 120, 220, 320 have been described and illustrated as having a lattice structure that defines an internal void 123, 223, 323, in some embodiments, the elements 120, 220, 320 may also include internal lattice structures (not shown) within the internal voids 123, 223, 323. The internal lattice structures may define one or more inner voids (not shown) in the internal voids 123, 223, 323. The one or more inner voids may interconnect with the one or more inner voids of other elements 120, 220, 320 in the structure 110, 210, 310 to define at least one interconnected inner void extending through the framework 110, 210, 310 in a respective interconnected void 115, 215, 315.

Although the elements 120, 220, 320 have been described and illustrated as having a lattice structure that defines an internal void 123, 223, 323, in some embodiments, the elements 120, 220, 320 may define multiple internal voids. In those embodiments, for each element 120, 220, 320, the multiple internal voids may be isolated from each other to define separate paths through the element 120, 220, 320 or may define multiple paths through the element 120, 220, 320 that intersect with each other. Further, for such embodiments, each of the multiple internal voids of an element 120, 220, 320 may interconnect with one or more of the multiple internal voids of an adjacent element 120, 220, 320 in the framework 110, 210, 310, thereby defining multiple interconnected voids extending through these interconnected elements 120, 220, 320 and the framework 110, 210, 310.

Although the interconnected voids 115, 215, 315 have been described and illustrated as being substantially vertical, in some embodiments, the interconnected voids 115, 215, 315 may extend in other orientations depending on the orientations of the elements 120, 220, 320 in the framework 110, 210, 310. For example, the elements 120, 220, 320 could be interconnected to define interconnected voids 115, 215, 315 that extend substantially horizontally or at an angle between vertical and horizontal.

Reference to any prior art in the specification is not an acknowledgment or suggestion that this prior art forms part of the common general knowledge in any jurisdiction or that this prior art could reasonably be expected to be understood, regarded as relevant, and/or combined with other pieces of prior art by a skilled person in the art.

By way of clarification and for avoidance of doubt, as used herein and except where the context requires otherwise, the term “comprise” and variations of the term, such as “comprising”, “comprises” and “comprised”, are not intended to exclude further additions, components, integers or steps

It will be understood that the invention disclosed and defined in this specification extends to all alternative combinations of two or more of the individual features mentioned or evident from the text or drawings. All of these different combinations constitute various alternative aspects of the invention.

1. A plant support structure for accommodating plants, the plant support structure including:
a framework including a plurality of elements interconnected to each other in a vertically extending arrangement, each element having a hollow lattice structure defining an internal void, wherein the internal void of each of the plurality of elements are interconnected and define at least one substantially vertical interconnected void extending through the plurality of elements and the framework.

2. The plant support structure of claim 1, further comprising a permeable substrate disposed in the at least one interconnected void, wherein the permeable substrate is configured to direct water flow through the at least one interconnected void.

3. The plant support structure of claim 2, wherein the permeable substrate is configured to support growth of plants growing in and through the at least one interconnected void.

4. The plant support structure of claim 2, wherein the permeable substrate is configured to at least partially guide growth of plants growing in and through the at least one interconnected void.

5. The plant support structure of claim 2, wherein the permeable substrate includes a plant growing media.

6. The plant support structure of claim 5, wherein the plant growing media includes a porous bag or lattice filled with a medium to support plant growth in and through the plant growing media.

7. The plant support structure of claim 2, wherein the permeable substrate includes a porous material.

8. (canceled)

9. The plant support structure of claim 1, wherein the framework has a first layer and a second layer of interconnected elements, the first layer being horizontally spaced apart from the second layer.

10. The plant support structure of claim 9, wherein:
at least one channel is defined between the first layer and the second layer; and
plant growing media is disposed in the at least one channel, the plant growing media disposed in the at least one channel is configured to direct water flow through the at least one channel.

11. The plant support structure of claim 10, wherein the plant growing media disposed in the at least one channel is configured to support plant growth of plants growing in the at least one channel.

12. The plant support structure of claim 10, or wherein the plant growing media disposed in the at least one channel includes a porous bag or lattice filled with a medium to support plant growth in the at least one channel.

13. The plant support structure of claim 1, wherein the framework at least partially guides growth of plants growing in the framework in and through the least one interconnected void and over and around the plurality of elements.

14. The plant support structure of claim 1, wherein the plant support structure is a façade of a building, a freestanding pavilion/wall, or a fence.

15. (canceled)

16. (canceled)

17. A plant support system accommodating and maintaining plants, the plant support system including:
a plant support structure according to claim 2; and
an irrigation system configured to deliver water to the permeable substrate.

18. The plant support system of claim 17, further comprising a water treatment pond located near a bottom end of the plant support structure, wherein the water treatment pond is configured to receive and treat water resulting from irrigation overflow through the framework of the plant support structure.

19. The plant support system of claim 18, further comprising a water storage tank configured to receive treated water from the water treatment pond.

20. The plant support system of claim 19, further comprising a cistern located at a height close or above the height of the plant support structure, wherein the cistern receives water from the water storage tank and provides the water to the irrigation system.

21. (canceled)

22. (canceled)

23. A method comprising, manufacturing or installing at a site a plant support structure of claim 2, and providing plants for growth on the plant support structure, wherein the plant growth is supported at least on part by the permeable substrate.

24. A method comprising, manufacturing or installing at a site a plant support system of claim 17, and providing plants for growth on the plant support structure, wherein the plant growth is supported at least on part by the permeable substrate.

25. The method of claim 23, wherein the plants are provided on the plant support structure by including seeds, spores, mineral, or other organic material that promotes growth of biological organisms in or on the permeable substrate.
